(19) United States
(12) Patent Application Publication
(10) Pub. No.: US 2026/0365442 A1
(43) Pub. Date: Nov. 19, 2026

(54) CONVEYOR, CONVEYOR BELT FOR A CONVEYOR OF THIS KIND, OPERATIONAL UNIT FOR A CONVEYOR BELT OF THIS KIND, AND USE OF A CONVEYOR BELT OF THIS KIND

(71) Applicant: SOMIC VERPACKUNGSMASCHINEN GMBH & CO. KG, Amerang (DE)

(72) Inventors: Maximilian König, Schleching (DE); Egbert Classen, Schonstett (DE)

(21) Appl. No.: 19/208,994

(22) Filed: May 15, 2025

(51) Int. Cl. B65G 21/20; B65G 15/58

(52) U.S. Cl. CPC B65G 21/2036; B65G 15/58; B65G 2249/045

(57) ABSTRACT

Disclosed is a conveyor with a conveyor belt having a contact surface and a valve chamber associated with the conveyor belt, the valve chamber having a valve seat that is connected to a suction line, and a valve closure element, the valve closure element being adjustable between a position that closes the valve seat and one that releases the valve seat, and further having at least one flow path that leads into the valve chamber, where, when the flow path is not covered by an object to be conveyed on the conveyor belt, a force acting in the direction of the closing position is exerted on the valve closure element, and, when the flow path is covered, a force acting in the direction of the releasing position is exerted on the valve closure element.

### CROSS REFERENCE TO RELATED APPLICATION

The entire contents of European Patent Application No. 24152567.4, filed in Europe on Jan. 18, 2024, are incorporated herein by reference.

### DESCRIPTION

The invention relates to a conveyor which comprises a conveyor belt with a contact surface, comprising a valve chamber associated with the conveyor belt, the valve chamber comprising a valve seat connected to a suction line, and a valve closure element, the valve closure element being adjustable between a position closing the valve seat and a position releasing the valve seat, and comprising at least one flow path leading into the valve chamber, when an end of the flow path associated with the contact surface is not covered by an object to be conveyed on the conveyor belt but not belonging to the conveyor, a force being exerted on the valve closure element by means of a flow arising from the suction line, which force pulls said element in the direction of its position closing the valve seat and, when an end of the flow path associated with the contact surface is covered by the object to be conveyed on the conveyor belt but not belonging to the conveyor, a force acting in the direction of the position of the valve closure element closing the valve seat being exerted on the valve closure element.

Such conveyors generally comprise a conveyor belt which is designed for transporting goods to be conveyed, lying thereon. In principle, the goods to be conveyed could also be conveyed merely placed on the conveyor belt. However, it is advantageous for an additional holding force to act on the goods to be conveyed, in order to prevent them slipping or falling off.

In practice, a holding force of this kind can be achieved by applying negative pressure to the goods to be conveyed. For this purpose, in general a vacuum box is attached under the conveyor belt, which generates a negative pressure via a vacuum blower, which negative pressure acts on the goods to be conveyed, via corresponding openings in the conveyor belt.

However, conveyor belts designed in this way must be provided with a high number of openings, in order to have sufficient coverage for the contact surface of the goods to be transported, since the point at which the product comes to lie on the vacuum conveyor belt is usually not known. Furthermore, a high number of openings is also advantageous with respect to the holding force which can be applied to the goods to be conveyed.

During normal operation, negative pressure nonetheless acts on openings that are not occupied by goods to be conveyed. This not only causes noise emissions, but also consumes unnecessarily large amounts of energy, since the vacuum blower has to be designed to be correspondingly powerful.

In order to provide a remedy here, EP 2 492 222 A1 proposed providing a space under the conveyor belt by raised mounting of the conveyor belt, and designing the conveyor belt to be resilient. This results in a closure of the suction line, upon application of negative pressure, if no goods to be conveyed are lying on the respective openings beside the suction line, and a holding force on the goods to be conveyed, as soon as said goods are lying on the conveyor belt. However, it has been found in practice that only a relatively low holding force can be achieved by this arrangement, with which force the goods to be conveyed cannot be held sufficiently reliably on the conveyor belt.

The object of the invention is therefore that of providing a conveyor that is improved in this respect.

This object is achieved according to the invention by a conveyor of the type mentioned at the outset, in which the at least one flow path leads into the base surface of a depression provided in the contact surface. Since the depression associated with the at least one flow path has a larger cross-sectional area than the simple opening of the flow path, the negative pressure generated by the vacuum blower acts on a larger surface area and thus causes a correspondingly greater holding force on the goods to be conveyed. If a specified cross-sectional area of the depression provides a sufficient holding force, then, furthermore, when the cross-sectional area of the depression is further increased the fan efficiency of the vacuum blower can be reduced. Therefore, a vacuum blower can be selected for the conveyor according to the invention which also takes up, overall, less space in the facility and/or requires a lower power consumption. Therefore, in a development of the invention, the conveyor can furthermore comprise a vacuum unit associated with the suction line, as part of the vacuum blower. A vacuum unit of this kind consumes less energy compared with the side channel compressors that are typically used, and therefore this is more sustainable and saves costs. Furthermore, less space is required in the facility and overall for the conveyor, since the vacuum unit is also generally of smaller dimensions.

A less complex design and simpler manufacture of the conveyor belt device according to the invention can for example be achieved in that the valve chamber is formed in the conveyor belt. This also achieves a reduced installation height of the conveyor belt device. Additionally or alternatively, this also allows for simpler replacement of older belts, without requiring complex modification of the old facility.

In order to be able to yet further simplify the manufacture and the design, in an embodiment of the invention a top layer of the conveyor belt, which is associated with the contact surface, or at least a portion of the top layer of the conveyor belt, which is associated with the contact surface, can form the valve closure element. This is also advantageous with regard to maintenance. In this case, the top layer can be arranged above a core belt. The negative pressure chamber, to which the vacuum blower is connected, can be located below the core belt.

Due to the repeated movements of the top layer between a position closing the valve seat and a position releasing the valve seat, damage may occur in this region due to increased loading. In order to prevent this, in a development of this embodiment it is proposed for the top layer of the conveyor belt, which is associated with the contact surface, to be designed to be resilient at least in a portion, for example using natural rubber and/or silicone rubber. Preferably a permanently elastic material may be used here. Preferably, the resiliently formed portion can be located above the valve seat. The purposeful use of the top layer material allows for further costs savings.

In order to reduce the loading of the top layer of the conveyor in the region above the valve seat, in a development of this embodiment it may be conceivable to form the valve closure element as a substantially planar element, which is pivotably deflectable out of the top layer.

In order to allow for the necessary movement of the valve closure element between a position closing the valve seat and a position releasing the valve seat, for example the substantially planar element can be resilient preloaded in the direction towards the position releasing the valve seat. A preload of this kind can preferably be achieved by a spring. An external, i.e. non-intrinsic, preload (for example due to the elasticity of the conveyor belt) in turn allows for a simple replacement of the preload element.

According to an embodiment, the valve closure element can be designed as a circular segment. A circular segment is advantageous in view of signs of wear, due to the lack of corners.

In order to achieve the simplest possible production of the conveyor, in one embodiment of the invention it is proposed to arrange the valve closure element with a hinge in the top layer.

In a development of the embodiment, the valve closure element can be designed to be substantially spherical. A spherical design allows for further simplification of the production method, since spherical closure elements are readily available and also easier to produce. This also reduces the costs of the production method.

In order that the valve closure element can also fulfil its function in a spherical design, it is proposed that the substantially spherical valve closure element can be elastically preloaded in the direction towards the position releasing the valve seat and/or can be urged by means of gravity in the direction towards the position releasing the valve seat. It is easy to see that by means of this structural design faulty or defective valve closure elements can be exchanged more easily, and thus also more efficiently and in a more cost-saving manner. It is no longer necessary, as is the case in practice, for the entire conveyor belt to be exchanged, but rather it is sufficient to exchange individual, defective or faulty valve closure elements. This can take place without having to carry out destructive measures on the conveyor belt, which again saves costs.

In a development of the invention, the conveyor belt of the conveyor can furthermore be an endlessly revolving conveyor belt, and the conveyor can comprise at least two deflecting rollers, around which the endless conveyor belt is guided.

According to a further aspect, the invention relates to a conveyor belt comprising a contact surface and a valve chamber associated with the conveyor belt, the valve chamber comprising a valve seat connected to a suction line, and a valve closure element, the valve closure element being adjustable between a position closing the valve seat and a position releasing the valve seat, and at least one flow path leading into the valve chamber, when an end of the flow path associated with the contact surface is not covered by an object to be conveyed on the conveyor belt but not belonging to the conveyor, a force being exerted on the valve closure element by means of a flow arising from the suction line, which force pulls said element in the direction of its position closing the valve seat and, when an end of the flow path associated with the contact surface is covered by the object to be conveyed on the conveyor belt but not belonging to the conveyor, a force acting in the direction of the position of the valve closure element closing the valve seat being exerted on the valve closure element, in which the at least one flow path leads, according to the invention, into the base surface of a depression provided in the contact surface. With regard to the advantages of this conveyor belt, reference is made to the above discussion of the conveyor according to the invention.

According to yet a further aspect, the invention relates to an operational unit for a conveyor belt according to the preceding aspect of the invention, comprising a valve assembly having at least one of the valve assembly features explained above. With regard to the advantages of this operational unit, reference is made to the above discussion of the conveyor according to the invention.

According to yet a further aspect, the invention relates to the use of a conveyor belt of the type discussed above in a conveyor according to the invention. With regard to the advantages of this use, reference is made to the above discussion of the conveyor according to the invention.

The invention will be explained in more detail in the following, on the basis of the accompanying drawings and with reference to a plurality of embodiments. In the drawings:

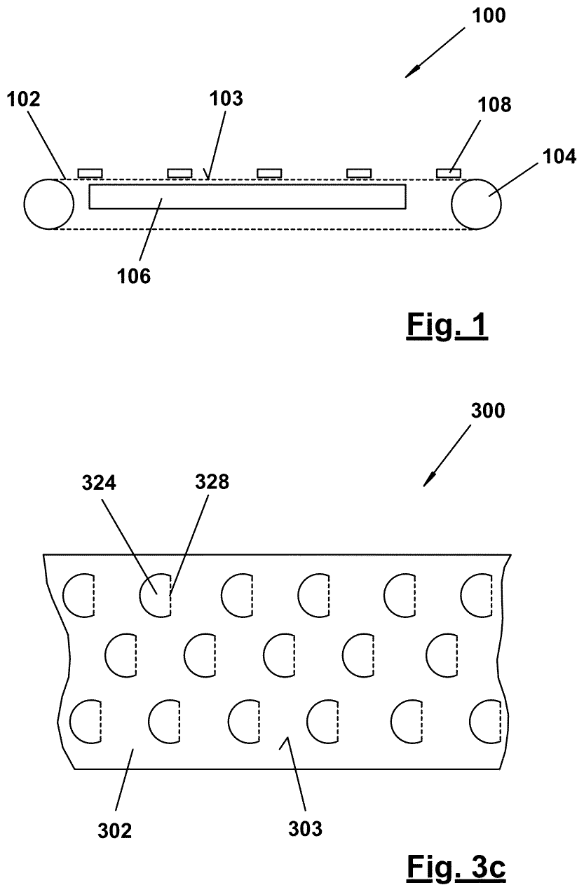

FIG. 1 is a schematic side view of the conveyor according to the invention;

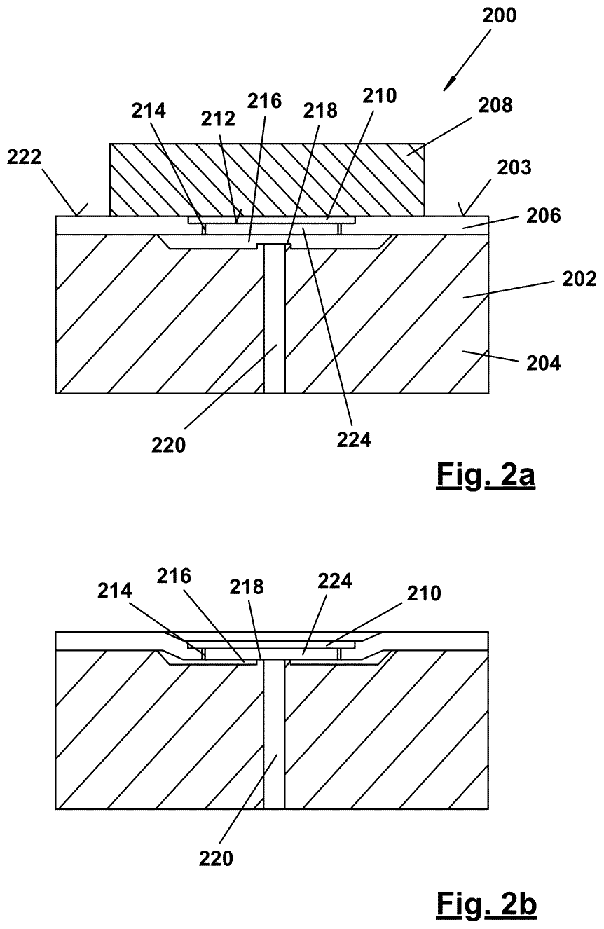

FIG. 2a is a sectional view through a first embodiment of the conveyor according to the invention, with goods to be conveyed lying thereon;

FIG. 2b is a view similar to FIG. 2a, but without goods to be conveyed lying thereon;

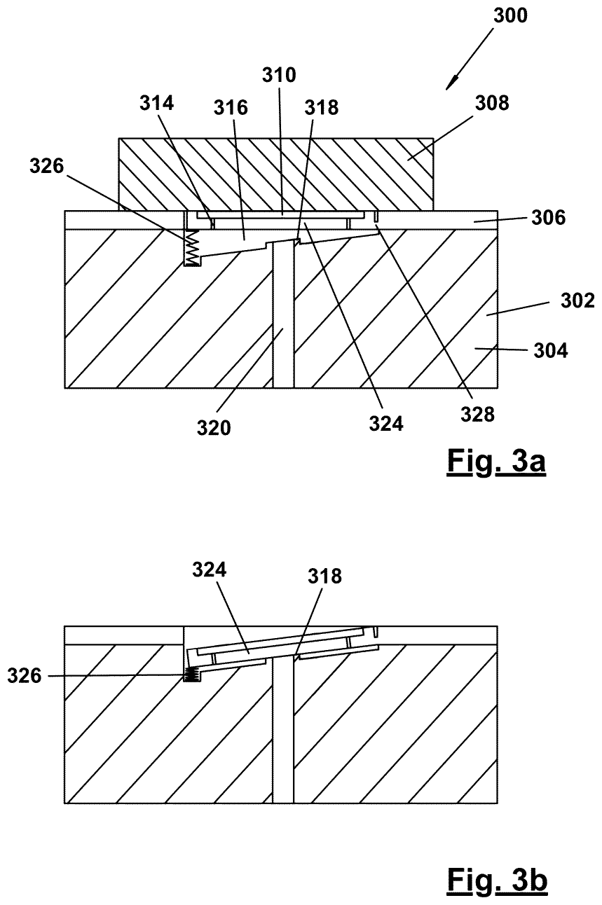

FIG. 3a is a sectional view through a second embodiment of the conveyor according to the invention, with goods to be conveyed lying thereon;

FIG. 3b is a view similar to FIG. 3a, but without goods to be conveyed lying thereon;

FIG. 3c is a plan view of the second embodiment of the conveyor according to the invention;

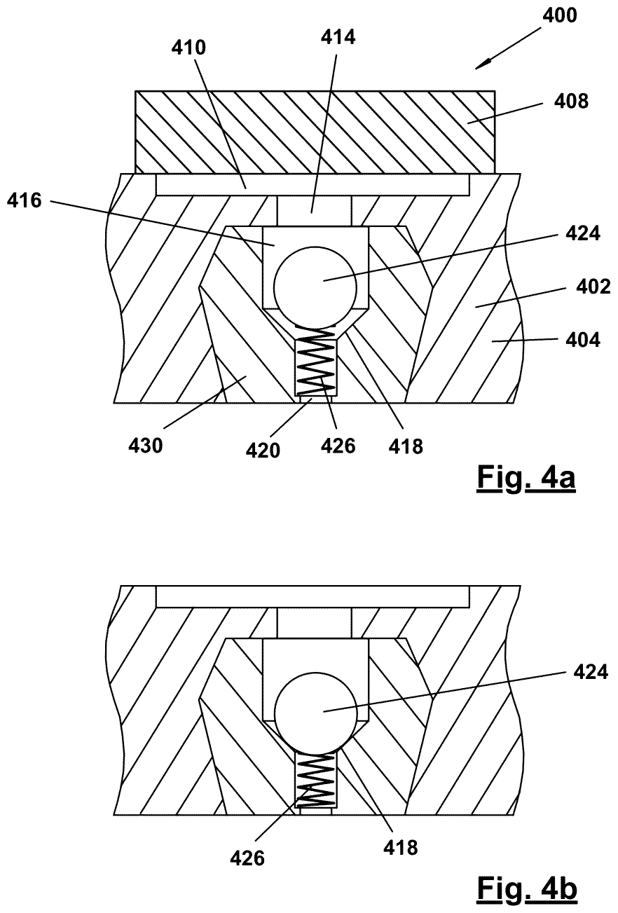

FIG. 4a is a sectional view through a third embodiment of the conveyor according to the invention, with an open valve closure element;

FIG. 4b is a view similar to FIG. 4a, but with a closed valve closure element;

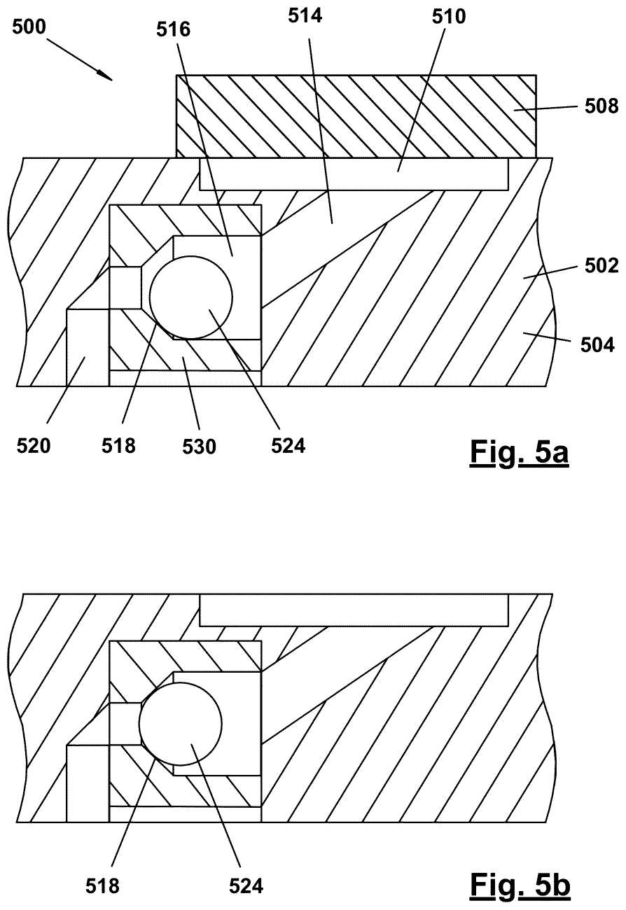

FIG. 5a is a sectional view through a fourth embodiment of the conveyor according to the invention, with an open valve closure element;

FIG. 5b is a view similar to FIG. 5a, but with a closed valve closure element;

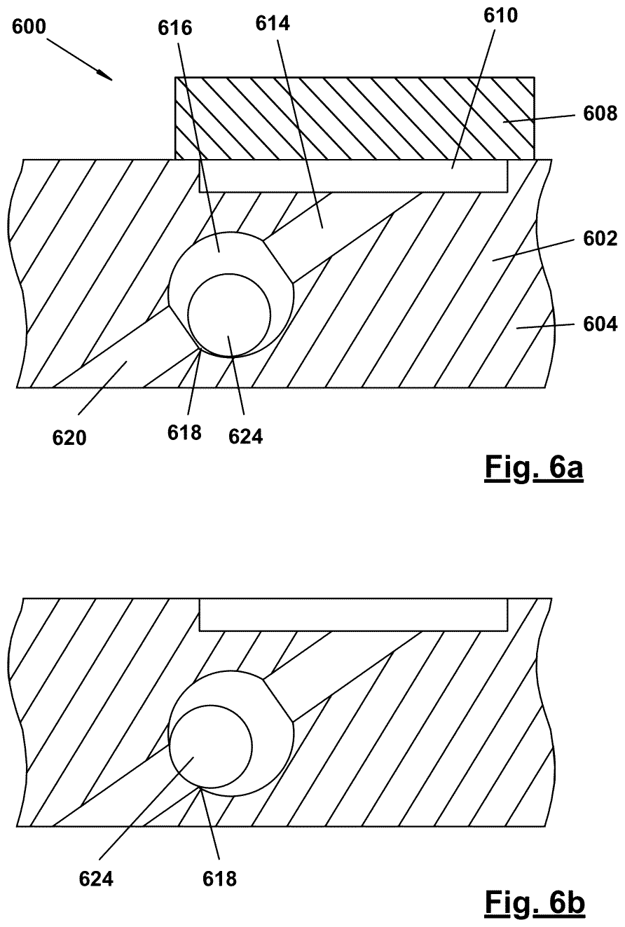

FIG. 6a is a sectional view through a fifth embodiment of the conveyor according to the invention, with an open valve closure element;

FIG. 6b is a view similar to FIG. 6a, but with a closed valve closure element; and

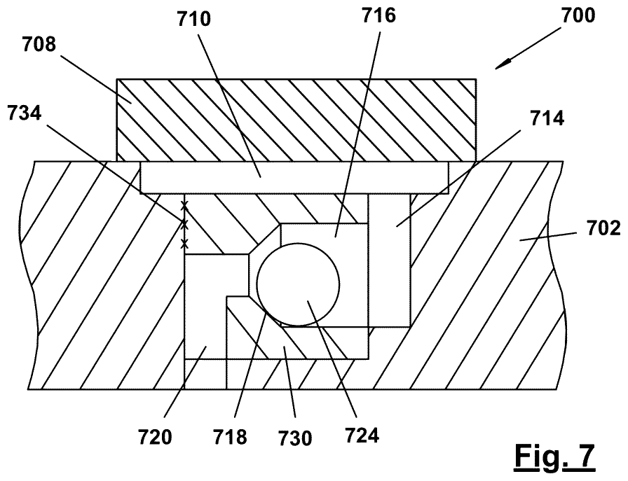

FIG. 7 is a sectional view through a sixth embodiment of the conveyor according to the invention, in which the valve assembly is formed in an operational unit.

In FIG. 1, a conveyor according to the invention is denoted very generally by 100. The conveyor 100 comprises a conveyor belt 102 having a contact surface 103 which is guided as a revolving belt conveyor with suction holes over two deflecting rollers 104, a vacuum box or a negative pressure chamber 106 which is arranged under the upper part of the conveyor belt 102. Furthermore, goods to be conveyed 108 are shown, which lie on the conveyor belt 102.

The upper run of the conveyor belt 102 is guided between the two deflecting rollers 104, in stretches over the vacuum box 106. The vacuum box 106 is connected to a vacuum unit (not shown). Instead of the vacuum unit, a vacuum blower or a side channel compressor can also be used.

Various embodiments are explained in the following figures, which all have the basic structure shown in FIG. 1.

FIG. 2a is a detailed view of a first embodiment of the conveyor 200 according to the invention. Here, goods to be conveyed 208 lying thereon are guided on a conveyor belt 202 over the negative pressure chamber (not shown here). The conveyor belt 202 comprises a permanently elastic and rigidly connected top layer 206, and a core belt 204 which can consist of a different material from the top layer 206, in particular a less resilient material.

Depressions 210 are provided in the top layer 206, which depressions can be designed to be round or also rectangular. In principle, however, any other geometry is also conceivable for this. Flow paths 214 lead into the base surface 212 of said depressions 210, which flow paths fluidically connect the depression 210 to a valve chamber 216. The valve chamber 216 is formed by a depression in the surface of the core belt 204, which rests on a surface 222 of the top layer 206, and said surface of the top layer 222. The valve chamber 216 is in turn fluidically connected to the negative pressure chamber via a suction line 220. A valve seat 218 is arranged at the mouth of the suction line 220 into the valve chamber 216. In the present embodiment, the valve closure element 224 is formed by the top layer 206.

FIG. 2a shows a position of the valve closure element 224 that releases the valve seat. What is essential for this position is that the goods to be conveyed 208 should fully cover the depression 210. Since as a result no air can be suctioned into the depression 210 and through the flow paths 214 into the valve chamber 216, there can also be no pressure drop over the flow paths 214. Consequently, the same pressure prevails in the depression 210 and the valve chamber 216, such that the inherent elasticity of the material of the top layer 206 lifts this from the valve seat 218.

FIG. 2b is a view similar to FIG. 2a, but without goods to be conveyed lying thereon. In this case, air is sucked through the flow paths 214, under the action of the negative pressure of the suction line 220, such that a pressure drop occurs over the flow paths 214. If the force resulting from the pressure difference between the depression 210 and the valve chamber 216 exceeds the inherent elasticity of the top layer 206, then this is pulled against the valve seat 218 and closes it.

FIG. 3a to 3c show a second embodiment of the conveyor according to the invention, which corresponds broadly to the first embodiment of FIGS. 2a and 2b. Therefore, in FIG. 3a to 3c analogous parts are provided with the same reference signs as in FIGS. 2a and 2b, but increased by 100. Furthermore, the conveyor 300 of FIG. 3a to 3c is described in the following only to the extent that it differs from the conveyor 200 of FIGS. 2a and 2b, to the description of which reference is otherwise made here.

In the case of the embodiment of FIG. 3a to 3c, too, goods to be conveyed 308 lying on the conveyor belt 302 are held thereon by means of negative pressure. Again, a core belt 304 and a permanently elastic top layer 306 form the conveyor belt 302. However, for the reasons explained below the top layer 306 does not need, here, to be formed of a permanently elastic material.

Specifically, in the embodiment of FIG. 3a to 3c the valve closure element 324 is formed as a substantially planar element, which can be pivotably deflected out of the top layer 306 and is connected thereto via a hinge portion 328. The hinge portion 328 can for example be designed as a notch.

A depression 310 is formed in the top layer 306, over which depression the goods to be conveyed 308 are laid, such that the depression 310 faces the goods to be conveyed 308. The depression 310, with goods to be conveyed 308 lying thereon, forms a chamber, which is fluidically connected via flow paths 314 in the valve closure element 324 to the valve chamber 316, and via the suction line 320 to the negative pressure chamber.

In this embodiment, the valve chamber 316 is formed by a side of the valve closure element 324 facing away from the goods to be conveyed 308 and the surface of the core belt 304 which is designed to substantially follow a movement path of the valve closure element 324. The valve seat 318 is arranged in the valve chamber 316. The depression 310 and the valve chamber 316 are interconnected via flow paths 314.

In order to achieve a position that releases an elastic preload of the valve closure element 324 in the direction towards the valve seat 318, a spring 326 is hinged to the deflectable end of the valve closure element 324, which spring is seated in the base surface of the valve chamber 316.

At this point it should be noted, for the sake of completeness, that the elastic preload can also be achieved by other means; as an example, here, an elastomer element or a pneumatic element is cited.

With regard to the function of the conveyor 300, reference can be made to the entire contents of the description of the function of the conveyor 200 of FIGS. 2a and 2b. All that is to be noted is that the cutting line formed around the valve closure element 324 has such a small cross-sectional area that it also makes no notable contribution to the holding force, compared with the depression 310.

It should be added, with respect to FIG. 3c, that the valve closure element 324 can be designed as a circular segment. This has advantages in particular with regard to production and to wear during use. However, different, other geometric designs of the valve closure element 324 are also conceivable; a rectangular shape is mentioned here merely by way of example.

FIGS. 4a, 4b, 5a, 5b, 6a and 6b show further embodiments of the conveyor 400, 500, 600 according to the invention, merely smaller, structural changes existing between FIG. 4a/4b and 5a/5b and 6a/6b. Common to all three embodiments is the fact that the valve closure element 424, 524, 624 is designed as a valve ball. All the elements, i.e. the valve chamber 416, 516, 616, the suction line 420, 520, 620, the valve seat 418, 518, 618 and the flow path 414, 514, 614 are formed in the conveyor belt 402, 502, 602, preferably in the core belt 404, 504, 604, such that a separate top layer can be omitted.

In these embodiments, the flow path 414, 514, 614 is the connection between the depression 410, 510, 610 in the surface of the core belt 404, 504, 604 and the interior 430, 530, 630 in the core belt 404, 504, 604, in which the valve ball 424, 524, 624 is arranged. As is also the case in the preceding embodiments, the flow path 414, 514, 614 is fluidically connected to the vacuum unit via the valve chamber 416, 516, 616 and the suction line 420, 520, 620.

In the embodiment of FIGS. 4a and 4b, the valve ball 424, similarly to the case of the embodiment of FIGS. 3a and 3b, is preloaded by a spring 426 into the open position of the valve, while the valve ball 524, 624 of the embodiments of FIG. 5a/5b, 6a/6b is urged by gravity into the open position of the valve.

With regard to the function of the conveyor 400, 500, 600 reference can be made to the entire contents of the description of the function of the conveyor 200 of FIGS. 2a and 2b or the modification thereof in FIG. 3a to 3c.

Finally, further structural differences between the embodiments of FIGS. 4a, 4b and/or 5a, 5b and/or 6a, 6b will be discussed.

In the embodiment of FIGS. 4a and 4b, the flow path 414, the valve chamber 416, the valve seat 418 and the suction line 420 are arranged, relative to one another, so as to be substantially orthogonal to the surface of the core belt 404. This results in the advantage that as little material as possible has to be removed from the conveyor belt 402 during production for the individual elements.

If, however, gravity is used as the restoring force, an arrangement of the valve seat 518, 618 that extends obliquely to the surface of the core belt 504, 604, and consequently also of the suction line 520, 620 in the direction of the valve chamber 516, 616, is advantageous. In the case of a spherical design of the valve chamber 616, the transition to the suction line 620 can form the valve seat 618.

Furthermore, the flow path 514, 614 is also arranged laterally on the valve chamber 516, 616, specifically on the side opposite the side on which the valve seat 518, 618 and the suction line 520, 620 are arranged. The flow path 514, 614 can be arranged obliquely or perpendicularly with respect to the surface of the core belt 504, 604 on which the goods to be conveyed (not shown) are laid. As a result of these structural features, the valve ball 524, 624 can change as easily as possible from the position closing the valve seat 518, 618 into a position releasing the valve seat 518, 618, and back, and can remain reliably in both positions. An arrangement of this kind can be seen from FIGS. 5a/5b and 6a/6b.

It should also be added that, in the case of the embodiments of FIGS. 5a/5b and/or 6a/6b, too, spring assistance similar to that in the embodiment of FIG. 4a/4b can be provided.

An operational unit is described in the following, as a further aspect of the invention, with reference to FIGS. 4a/4b, 5a/5b and 7.

An operational unit 430, 530, 730 of the conveyor 400, 500, 700 comprises the valve chamber 416, 516, 716, the valve closure element 424, 524, 724, which can be spherical, the valve seat 418, 518, 718, and a part of the suction line 420, 520, 720.

The operational unit 400, 500 from FIGS. 4a/4b and 5a/5b is arranged in the conveyor belt 402, 502 such that it can be removed from the conveyor belt 408, 508 from below (with respect to the surface of the conveyor belt 402, 502 on which the goods to be conveyed 408, 508 are placed) and as an entire unit.

In contrast, the operational unit 730 from FIG. 7 is arranged in the conveyor belt 702 in such a way that indentation for this can be worked in, e.g. milled, from above (with respect to the surface of the conveyor belt 702 on which the goods to be conveyed 708 (not shown) are placed). This is possible insofar as the operational unit 730 seals the edge 734 between the operational unit 730 and the conveyor belt 702, on the side above the suction line 720 and under the depression 710 (with respect to the surface of the conveyor belt 702 on which the goods to be conveyed 708 (not shown) are placed).

It is easily evident that an arrangement of the denoted elements as an operational unit 430, 530, 730 is advantageous, since an exchange of defective or faulty units can thus take place easily, quickly and cost-effectively. Furthermore, existing conveyors can be retrofitted with the operational units 430, 530, 730 easily, quickly and cost-effectively-only the depression 410, 510, 610, 710, the flow path 414, 514, 614, 714, the indentation for the operational unit 430, 530, 730, and a part of the suction line 420, 520, 620, 720 have to be worked, e.g. milled, into the conveyor belt.

In principle, however, it is also conceivable to work the required cavities directly into the belt, for example either during curing of the belt material and/or by retrospective mechanical drilling/milling, such that no separate “valve housing” has to be produced and glued into the belt.

1. Conveyor, comprising:
a conveyor belt having a contact surface;
a valve chamber associated with the conveyor belt, the valve chamber comprising a valve seat that is connected to a suction line, and a valve closure element, the valve closure element being adjustable between a position that closes the valve seat and one that releases the valve seat; and
at least one flow path that leads into the valve chamber,
wherein:
when an end of the flow path associated with the contact surface is not covered by an object to be conveyed on the conveyor belt but not belonging to the conveyor, a force is exerted on the valve closure element by means of a flow arising from the suction line, which force pulls said element in the direction of its position closing the valve seat;
when an end of the flow path associated with the contact surface is covered by the object to be conveyed on the conveyor belt but not belonging to the conveyor, a force acting in the direction of the position of the valve closure element closing the valve seat is exerted on the valve closure element; and
the at least one flow path leads into a base surface of a depression provided in the contact surface.

2. Conveyor according to claim 1,
further comprising a vacuum unit associated with the suction line.

3. Conveyor according to claim 1,
wherein the valve chamber is formed in the conveyor belt.

4. Conveyor according to claim 1,
wherein a top layer of the conveyor belt, which is associated with the contact surface, or at least a portion of the top layer of the conveyor belt, which is associated with the contact surface, forms the valve closure element.

5. Conveyor according to claim 1,
wherein a top layer of the conveyor belt, which is associated with the contact surface, is designed to be resilient at least in a portion, for example using natural rubber and/or silicone rubber.

6. Conveyor according to claim 1,
wherein the valve closure element is designed as a substantially planar element, which can be pivotably deflected out of a top layer of the conveyor belt.

7. Conveyor according to claim 6,
wherein the substantially planar element is resiliently preloaded in the direction of the position releasing the valve seat.

8. Conveyor according to claim 6,
wherein the valve closure element is designed as a circular segment.

9. Conveyor according to claim 6,
wherein the valve closure element is arranged with a hinge in the top layer.

10. Conveyor according to claim 1,
wherein the valve closure element is designed to be substantially spherical.

11. Conveyor according to claim 10,
wherein the substantially spherical valve closure element is elastically preloaded in the direction towards the position releasing the valve seat and/or is urged by means of gravity in the direction towards the position releasing the valve seat.

12. Conveyor according to claim 11,
wherein the conveyor belt is an endlessly revolving conveyor belt and the conveyor comprises at least two deflecting rollers, around which the endless conveyor belt is guided.

13. Conveyor belt, comprising:
a contact surface;
a valve chamber associated with the conveyor belt, the valve chamber comprising a valve seat that is connected to a suction line, and a valve closure element, the valve closure element being adjustable between a position that closes the valve seat and one that releases the valve seat; and
at least one flow path that leads into the valve chamber,
wherein:
when an end of the flow path associated with the contact surface is not covered by an object to be conveyed on the conveyor belt but not belonging to the conveyor, a force is exerted on the valve closure element by means of a flow arising from the suction line, which force pulls said element in the direction of its position closing the valve seat;
when an end of the flow path associated with the contact surface is covered by the object to be conveyed on the conveyor belt but not belonging to the conveyor, a force acting in the direction of the position of the valve closure element closing the valve seat is exerted on the valve closure element; and
the at least one flow path leads into a base surface of a depression provided in the contact surface.
